(19) United States
(12) Patent Application Publication
(10) Pub. No.: US 2010/0097644 A1
(43) Pub. Date: Apr. 22, 2010

(54) IMAGE PROCESSING APPARATUS, SERVER APPARATUS, AND CONTROL METHOD THEREOF

(75) Inventor: Takeshi Takahashi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/578,429

(22) Filed: Oct. 13, 2009

(30) Foreign Application Priority Data
Oct. 15, 2008 (JP) 2008-266505

(51) Int. Cl. G06F 15/00; G06F 15/16

(52) U.S. Cl. 358/1.15; 709/203

(57) ABSTRACT

An image processing apparatus includes a connection unit configured to connect to a server apparatus, an acquisition unit configured to acquire a user interface (UI) component concerning a service which can be used by a user in a client terminal apparatus and has an output format capable of processing the output format of the service by a device of the image processing apparatus among services provided by the server apparatus from the server apparatus, a generation unit configured to generate a preview component for an output material based on an output setting of the UI component acquired by the acquisition unit and an output setting of the UI component of the device of the image processing apparatus, a combining unit configured to combine the UI component acquired by the acquisition unit, the UI component of the device of the image processing apparatus, and the preview component generated by the generation unit into a single UI screen, and a transmission unit configured to transmit the UI screen to the client terminal apparatus.

### BACKGROUND OF THE INVENTION

1. Field of the Invention

The present invention relates to an image processing apparatus, a sever apparatus, and a control method thereof.

2. Description of the Related Art

Recently, in the progression of networking of an office, it is common that an output device is also connected to a network to execute output processing such as printing and facsimile (FAX) transmission through the network based on an output command from each terminal apparatus (terminal) in an office. Further, in association with enhanced functionality of the output device, the setting of an output format (color/monochrome designation, bookbinding form output, duplex printing or the like) has been diversified. As choices of settings are diversified, a user frequently notices differences in output format from that intended by the user. Thus, a preview function has become more important which checks an output format beforehand.

Conventionally, when output is executed to a device, a driver dedicated to the device, installed in a terminal, communicates with an output device, thereby acquiring the capability and the state of a target output device on the terminal side to display practicable information on the output format on a driver user interface (UI) on the terminal side. The capability and the state of the target output device refer to the situation of device option installation such as a finisher, the state of paper feed, and the state of the amount of ink/toner or the like. The driver on the terminal side controls a user interface based on the acquired information to allow not only a settable format item to be displayed to a user but also an output preview according to a set item selected by a user to be displayed. Among these output previews, there is also an output preview that dynamically generates a preview so that a user changes the selected state of the displayed format item, thereby switching an output preview.

Now, when output target data is not placed on a user terminal but on a server (server apparatus) on a network, an output preview reflecting data cannot be generated only by communication between the driver on the user terminal and the output device. In this case, a preview can be generated by adding processing for acquiring data on the designated server. However, in these above-described cases, it is assumed that a dedicated driver corresponding to a driver to be used or a transfer application which plays a role alternative to the dedicated driver is installed in a user terminal. However, recently, from the viewpoint of maintenance or security of each terminal, it may be a problem that the driver or the transfer application for the output device is installed in each terminal.

For example, when the driver or the transfer application has been installed, if obstacles are contained in these programs, it is necessary to install an updated program of these drivers or transfer applications. This is a significantly large load for a manager in an office terminal. Further, when the driver or the transfer application contains weaknesses in its security, the whole network of an office may also be subject to vulnerabilities.

Recently, a system is desired which accesses a web server or an output device by a “thin client” that accepts use of only a general-purpose browser

Further, when data is downloaded from a server to a terminal for generating a preview, data is normally placed in a directory for a temporary file of an operating system (OS) as a temporary file. In this case, if a restriction (authority) such that “even if printing can be executed, electronic data cannot be acquired” is provided on a server system, an electronic file can easily be acquired from the directory for the temporary file during printing. Thus, there is also a problem that data may be leaked.

On the other hand, as discussed in Japanese Patent Application Laid-Open No. 2007-328639, a system is developed in which a dedicated driver of a device to be used is installed on a server in advance and the server communicates with an output device. In this case, with respect to a preview function, it is possible for the server to directly acquire information on an output format (output form) from the device, generate a preview on the server side, and provide it to a terminal. Further, a command can be issued to the server by only a general-purpose browser. Thus, it is not necessary to install a dedicated driver or a transfer application on a user terminal.

However, when the server is present on the Internet, normally, access is hardly accepted from the server to an output device present on a local area network (LAN) in an office because of potential security concerns. In this case, communication from a dedicated driver installed in the server to a device cannot be executed. Thus, the capability and the state of an output device cannot be acquired. Accordingly, there is a problem that a preview reflecting the capability and the state of the output device also cannot be generated, and print processing from the server also cannot be executed.

Further, when an image present on a web server on the Internet is output by an output device present on a LAN, a mechanism referred to as uniform resource locator (URL) print is developed. The URL print is realized by the following mechanism.

First, the URL which indicates an objective image present on the web server is checked to deliver it to an output device. There are several methods for delivering the URL to an output device. For example, there is a method which uses an infrared communication function incorporated into the terminal of a cellular phone or the like to transmit the URL of an image to an output device which similarly holds the infrared communication function. The output device to which the URL is delivered accesses a web server based on the delivered URL to execute download of a target image and output processing of the image. In this case, access is executed from the output device side to the server to acquire the image. Thus, even if the output device is present on a LAN, data on the server can be output.

However, as described above, even if the URL print is executed, the following problems exist:
1. The URL of the target image present on the web server is only delivered from the terminal. Thus, the contents of an actual document and a preview reflecting a print format cannot be checked on the terminal side.
2. In the URL print, when a plurality of documents is intended to be output as one output material (e.g., when a plurality of images is integrally output as one bookbinding form), it is necessary to acquire a plurality of URLs on the terminal side in advance. More specifically, it is a prerequisite that determination of an output target, determination of its URL, and arrangement of an output order (designation which target image to be the head and subsequently what order the target image to be output among a plurality of target images) are executed on the terminal side in advance before the target image is transmitted to the output device. It is necessary for a user to devise to write the plurality of URLs down or memorize them. Thus, operability is significantly poor.
3. When a target is not a simple image, i.e., a simple URL on the sever, but a result obtained by processing data on the server by a service intended to be output from the device, it is necessary to execute processing beforehand on the server. Also in this case, preliminary preparation for executing processing as processing separated from output of the device is required and post processing so as to discard a document of a processing result after output is also required. Thus, there is a problem of inconvenience that imposes various operations on a user.

### SUMMARY OF THE INVENTION

The present invention is directed to a method capable of providing a preview considering the output format of both a server apparatus and an image processing apparatus, and also improving operability for output.

According to an aspect of the present invention, an image processing apparatus includes a connection unit configured to connect to a server apparatus based on identification information on the server apparatus contained in a connection request from a client terminal apparatus, an acquisition unit configured to acquire a user interface (UI) component for a service which can be used by a user in the client terminal apparatus and has an output format capable of processing the output format of the service by a device of the image processing apparatus among services provided by the server apparatus from the server apparatus based on session information concerning a connection between the client terminal apparatus contained in the connection request and the server apparatus and the output format that can be processed by the device of the image processing apparatus, a generation unit configured to generate a preview component for an output material based on an output setting of the UI component acquired by the acquisition unit and an output setting of the UI component of the device of the image processing apparatus, a combining unit configured to combine the UI component acquired by the acquisition unit, the UI component of the device of the image processing apparatus, and the preview component generated by the generation unit into a single UI screen, and a transmission unit configured to transmit the UI screen combined by the combining unit to the client terminal apparatus.

According to another aspect of the present invention, a server apparatus includes a receiving unit configured to receive an acquisition request of a UI component concerning a service which can be used by a user in a client terminal apparatus and has an output format capable of processing the output format of the service by a device of an image processing apparatus among services provided by the server apparatus, containing session information concerning a session of the client terminal apparatus and the server apparatus and capability information on the device of the image processing apparatus from the image processing apparatus, a service information acquisition unit configured to acquire service information concerning a service which can be used by a user in the client terminal apparatus based on the session information contained in the acquisition request received by the receiving unit, a determination unit configured to determine whether an output format concerning a service indicated by the service information is an output format which can be processed by the device of the image processing apparatus based on the service information acquired by the service information acquisition unit and the capability information on the device of the image processing apparatus contained in the acquisition request received by the receiving unit, and a transmission unit configured to transmit the UI component concerning the service determined to be an output format which can be processed by the device of the image processing apparatus by the determination unit to the image processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of a system configuration of an integrated output system.

FIG. 2 is a diagram illustrating an example of a hardware configuration between a host computer and an image processing apparatus.

FIG. 3A is a diagram illustrating an example of a system configuration of a service providing system.

FIG. 3B is a diagram illustrating an example of a system configuration of an output device system.

FIG. 4 is a diagram illustrating an example of a use case.

FIG. 5A is a diagram illustrating an example of a user interface (UI) which is viewed from a browser of a client terminal directly before final printing processing.

FIG. 5B is a diagram illustrating an example of combination of portlets.

FIG. 5C is a diagram illustrating an example of a UI when a web application server is used.

FIG. 5D is a diagram illustrating an example of access to an integrated output system.

FIG. 6A is a flowchart illustrating an example of processing which is executed on an output device.

FIG. 6B is a flowchart illustrating an example of processing which is executed on an output device.

FIG. 6C is a flowchart illustrating an example of processing which is executed on a web application server.

### DESCRIPTION OF THE EMBODIMENTS

Various exemplary embodiments, features, and aspects of the invention will be described in detail below with reference to the drawings.

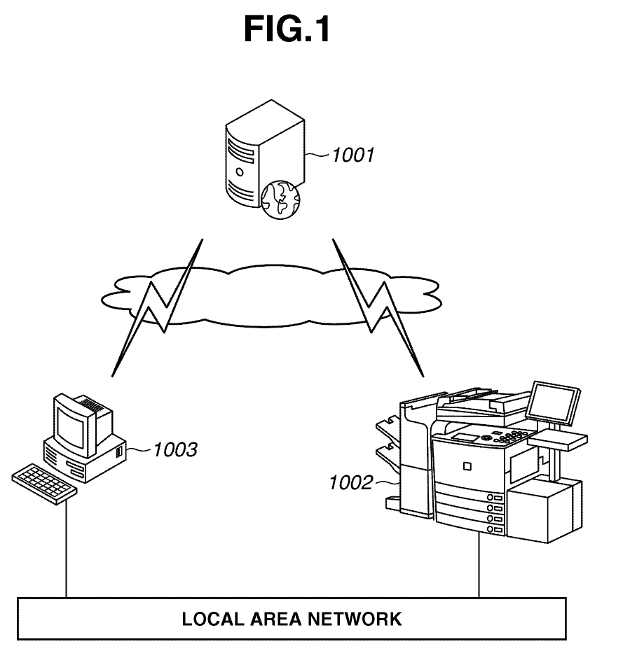

FIG. 1 is a diagram illustrating an example of a system configuration of an integrated output system.

A web application server 1001 which is an example of a server apparatus provides various services to data such as a document, a file, and an image.

A service provides a function such as, storage and input/output of data, a summary, partial extraction, combining and format conversion (e.g., conversion of formats or the like, conversion of display styles or the like) of data, and conversion of data format (e.g., conversion of portable document format (PDF) or the like, conversion of data structure and format itself).

Further, the web application server 1001 also includes a function of distributing a UI for setting and changing a parameter which affects operation and an executed result when a service is executed by a format (hypertext markup language (HTML) or the like) displayable on a browser. The web application server 1001 is disclosed on the Internet and can be accessed from a general office.

An output device 1002 which is an example of an image processing apparatus includes an output function of executing printing, FAX transfer and email transfer of data received in a predetermined format according to a designated setting. Further, the output device 1002 also includes a function of detecting the state of paper fed into the device and the installation of finisher equipment to grasp the current capability and state of the output device 1002. Furthermore, the output device 1002 also includes an HTML communication function connectable to a web server or the like. The output device 1002 also includes a web server function of receiving an HTML connection from an external web server to transmit thereto.

client terminal apparatus (client terminal 1003) is a personal computer (PC) installed with a general-purpose browser that is connected to a web server on the Internet and an intranet, and can draw and display an HTML document to be delivered from a web server. Operation of the integrated output system according to the present exemplary embodiment is performed by a user using a general-purpose browser of this terminal.

More specifically, the output device 1002 and the client terminal 1003 are installed in a LAN within an office, and have an environment which cannot be accessed from an external network such as the Internet. It is not accessible from the web application server 1001 to both the output device 1002 and the client terminal 1003. Of course, it is accessible from a LAN to the Internet, and from the output device 1002 and the client terminal 1003 to the web application server 1001.

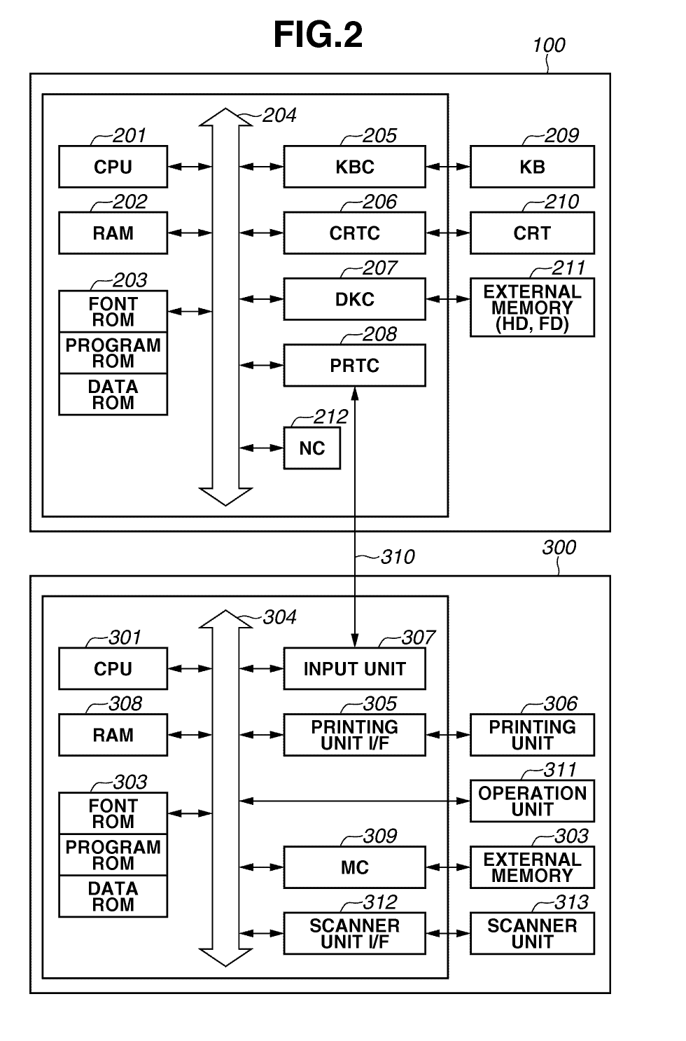

FIG. 2 is a diagram illustrating an example of a hardware configuration between a host computer 100 and an image forming apparatus 300.

The host computer 100 to be mentioned in FIG. 2 illustrates a computer which includes the web application server 1001. The image forming apparatus 300 illustrates a computer which includes the output device 1002.

First, a configuration of the host computer 100 will be described. More specifically, a hardware configuration illustrated in FIG. 2 corresponds to a hardware configuration of a general information processing apparatus. A hardware configuration of the general information processing apparatus can be applied to the host computer 100 in the present exemplary embodiment.

In FIG. 2, a central processing unit (CPU) 201 executes a program such as an OS and an application stored in a read only memory (ROM) 203 or loaded from a hard disk 211 to a random access memory (RAM) 202. Processing of each flowchart which will be described later is realized by causing the CPU 201 to execute processing based on a program. The RAM 202 functions as a main memory or a work area for the CPU 201. A keyboard controller (KBC) 205 controls a keyboard 209 and key input from a pointing device (not shown). A cathode ray tube (CRT) controller (CRTC) 206 controls display on a CRT display 210. A disk controller (DKC) 207 controls data access in a hard disk (HD) 211, a floppy disk (FD) or the like which stores various kinds of data. A printer controller (PRTC) 208 controls an interchange of a signal with the connected image forming apparatus 300. A line 310 for connection can apply various connection forms such as an LAN and a universal serial bus (USB). A network controller (NC) 212 is connected to a network to execute communication control processing with other equipment connected to a network. It may be a form so as to be further connected to other image forming apparatus and peripheral equipment via a network.

More specifically, the host computer 100 is described as indicating a computer including the web application server 1001. However, it may also be provided as indicating a computer including the client terminal 1003.

Next, a configuration of the image forming apparatus 300 will be described. As illustrated in FIG. 2, in the image forming apparatus 300, a CPU 301 is the CPU of the image forming apparatus 300, and controls each block connected to a system bus 304 based on a control program stored in an ROM 302 or an external memory 303. An image signal generated by the processing of the CPU 301 is output to a printing unit 306 (image forming apparatus engine) as output information via a printing unit interface (I/F) 305. Further, the CPU 301 allows communication processing with the host computer 100 via an input unit 307. The CPU 301 can notify the host computer 100 of information in the image forming apparatus 300. More specifically, the printing unit 306 connects option hardware (finisher or the like) (not illustrated), thereby allowing a function to be expanded, and also allows the presence or the absence of option hardware and performance to be detected. A program ROM in the ROM 302 stores a control program or the like on the CPU 301. Font data or the like to be used when output information is generated is stored in an ROM for a font in the ROM 302. In an image forming apparatus without the external memory 303 such as a hard disk, information or the like to be used on the host computer 100 is stored in an ROM for data in the ROM 302.

An RAM 308 is an RAM which functions as a main memory of the CPU 301, a work area or the like. The RAM 308 is configured so as to allow a memory capacity to be expanded by an option RAM to be connected to an added port (not illustrated). Further, the RAM 308 is used in an output information development area, an environmental data storage area, a nonvolatile RAM (NVRAM) or the like.

In the external memory 303, access is controlled by a memory controller (MC) 309. The external memory 303 is connected as option, and stores font data, an emulation program, format data or the like. Further, an operation unit 311 includes a switch for operation, a light emitting diode (LED) display instrument and the like.

A scanner interface (I/F) 312 executes correction, processing and editing to image data received from a scanner unit 313. The scanner unit 313 inputs reflected light obtained by executing exposure scanning of an image on a document to a charge coupled device (CCD), thereby converting information on the image into an electric signal. Further, the scanner unit 313 converts the electric signal into a luminance signal including each color of red (R), green (G) and blue (B) to read the luminance signal as image data. When a user instructs start of reading from the operation unit 311, document reading instruction is provided to the scanner unit 313. When the scanner unit 313 receives this instruction, the scanner unit 313 executes operation for reading a document. More specifically, a method for reading a document may be the form of an automatic feeding method which is set to a document feeder (not illustrated). Further, it may be a method which places a document on a glass surface (not illustrated) and moves an exposure unit, thereby executing scan of the document.

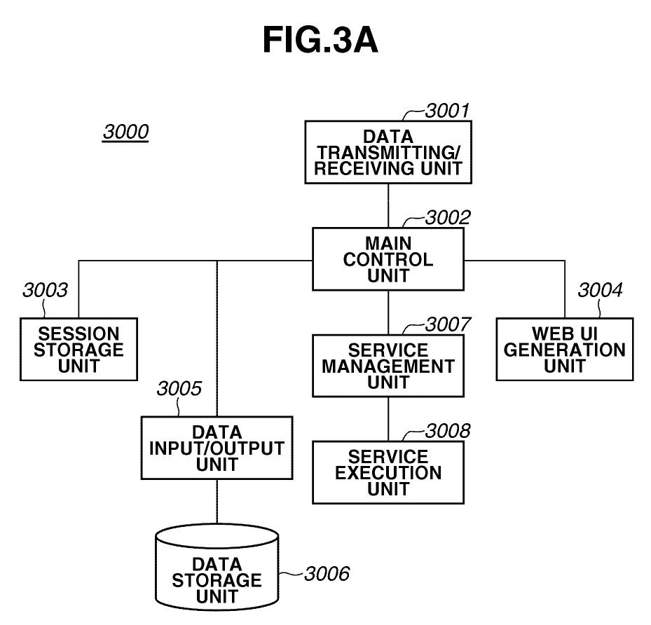

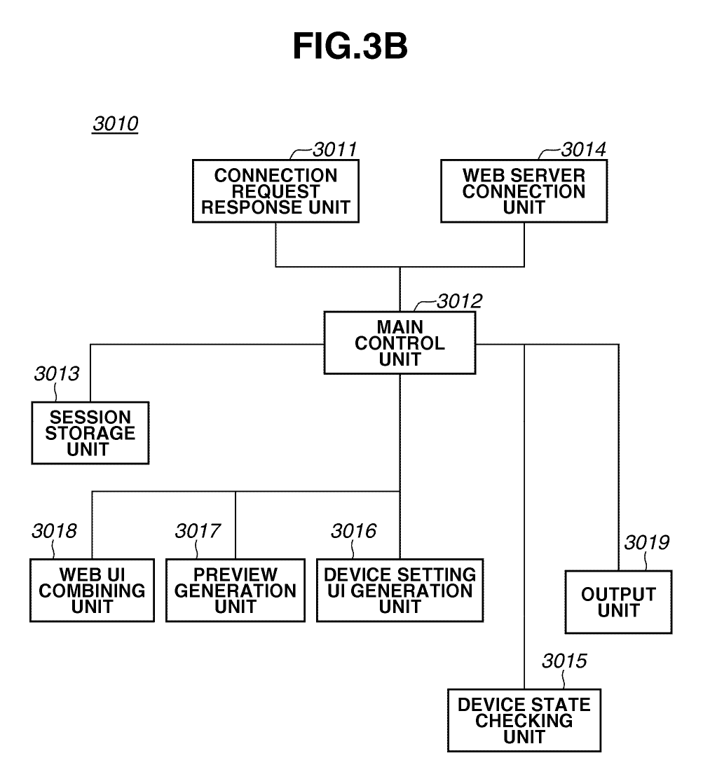

FIG. 3A is a diagram illustrating an example of a system configuration of a service providing system 3000. Further, FIG. 3B is a diagram illustrating an example of a system configuration of an output device system 3010.

The service providing system 3000 is software which operates on the web application server 1001. Each of components shown by a rectangle corresponds to a software component. An arrangement configuration of the components depends on a system configuration and a platform.

Further, the output device system 3010 is software which operates on the output device 1002. Each of components shown by a rectangle corresponds to a software component. An arrangement configuration of the components depends on a system configuration and a platform.

A main control unit 3002 controls the entire system of the service providing system 3000 according to the present exemplary embodiment to execute commands and management to each unit which will be described later.

A data transmitting and receiving unit 3001 receives instructions issued by a user via a browser in the client terminal 1003 and a connection request from a device, and transmits a result obtained by receiving commands from the main control unit 3002 to the client terminal 1003 and the output device 1002.

A session storage unit 3003 generates session information for indicating access from the same user after the user accesses the service providing system 3000 via a browser and further via an output device in the client terminal 1003. Further, the session storage unit 3003 associates various kinds of information which are repeatedly used with session information to hold it until a user ends (log out) access to an integrated output system or a session is terminated by an automatic time-out.

A web UI generation unit 3004 receives commands from the main control unit 3002 and generates a web UI (HTML) corresponding to the situation. Now, the web UI which is generated by the web UI generation unit 3004 is not limited to an HTML but may be imbedded with a script language such as Java (trademark) Script.

A data input/output unit 3005 receives commands from the main control unit 3002, and executes operation such as registration, storage, update and retrieval of data to a data storage unit 3006.

The data storage unit 3006 stores not only input data, but also a folder in which data is stored, its attribute, and its security level. The data storage unit 3006 is controlled by, for example the data input/output unit 3005.

A service management unit 3007 receives commands from the main control unit 3002 to be operated. The service management unit 3007 executes information management of each service which is held by the service providing system 3000 and management of setting information such as an input/output parameter. Further, when a plurality of services is continuously executed, the service management unit 3007 executes call control of a service such as its sequence.

A service execution unit 3008 is a unit configured to execute actual service processing. The service execution unit 3008 executes specific data processing and processing such as collection of necessary information accompanied with data input/output.

A main control unit 3012 controls the entire system of the output device system 3010 according to the present exemplary embodiment to execute commands and management to each unit which will be described later.

A connection request response unit 3011 receives instructions issued by a user via a browser in the client terminal 1003 to transmit it to the main control unit 3012 and transmits a result obtained by receiving commands from the main control unit 3012 to the client terminal 1003.

A session storage unit 3013 generates session information for indicating access from the same user after the user accesses the output device system 3010 via a browser in the client terminal 1003. Further, the session storage unit 3013 associates various kinds of information which are repeatedly used with session information to hold it until a user ends (log out) access to an integrated output system or a session is terminated by an automatic time-out.

A web server connection unit 3014 receives commands from the main control unit 3002, connects to the data transmitting/receiving unit 3001 of the service providing system 3000, transmits commands receiving from the main control unit 3012, also receives its result, and transmits to the main control unit 3012.

A device state checking unit 3015 receives commands from the main control unit 3002, checks the state and the capability of a device itself such as the state of paper feed and the situation of option installation such as a finisher, and notifies the main control unit 3012.

A device setting UI generation unit 3016 generates a device setting UI as a format distributable to a client terminal such as an HTML based on the commands of the main control unit 3002. Now, the UI which is generated by the device setting UI generation unit 3016 is not limited to an HTML but may be imbedded with a script language such as Java Script.

A preview generation unit 3017 dynamically generates a preview reflecting processing of both services on the web application server 1001 and the output device 1002 based on an output preview from the service providing system 3000 and output setting information of an output device according to the commands of the main control unit 3012. When the service providing system 3000 does not include a distribution function of a preview image, once output is executed from the service providing system 3000 to the output device system 3010, an image is converted based on its data, and a preview reflecting the setting of an output device is generated.

A web UI combining unit 3018 combines the following three UIs:
(1) service setting UI acquired from the service providing system 3000 through the web server connection unit 3014;
(2) device setting UI generated by the device setting UI generation unit 3016; and
(3) preview providing UI reflecting an output setting from the service providing system 3000 and an output setting of an output device generated by the preview generation unit 3017.

An output unit 3019 actually executes output processing of data commanded from the main control unit 3012 (data acquired from the service providing system 3000 via the web server connection unit 3014) with the commanded setting.

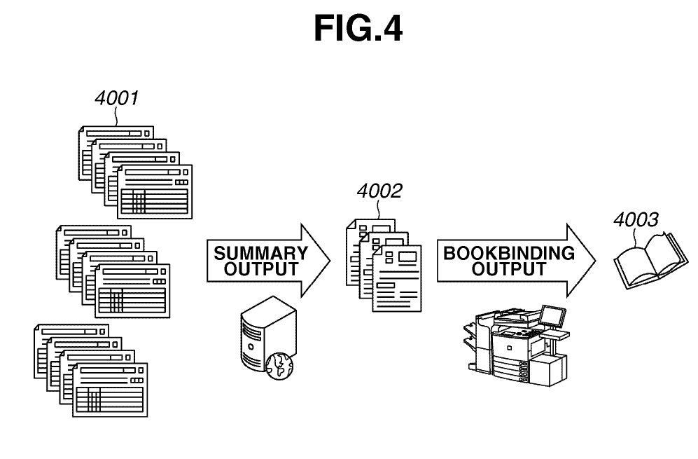

FIG. 4 is a diagram illustrating an example of a use case.

In a document data group 4001 for use in this use case, a plurality of documents becomes a target. Data on this document data group 4001 is stored in the web application server 1001.

A result (intermediate product) 4002 is obtained by summarizing to collect the document data group 4001. This summary processing is executed by a summary service which is provided by the service providing system 3000. Incidentally, in this use case, as an example of a data processing service, description will be made using a summary service. However, a function which is provided by the data processing service may also be other than summary. For example, a function such as partial extraction, combining and format conversion (e.g., form conversion or the like, conversion of display style or the like) of data, and conversion of a data format (e.g., PDF conversion, encryption, decoding, and conversion of data structure and format) may be employed.

A result 4003 is a result obtained by bookbinding the intermediate product 4002 to output it. This bookbinding output processing is a known technique and executed by a function of the output device 1002.

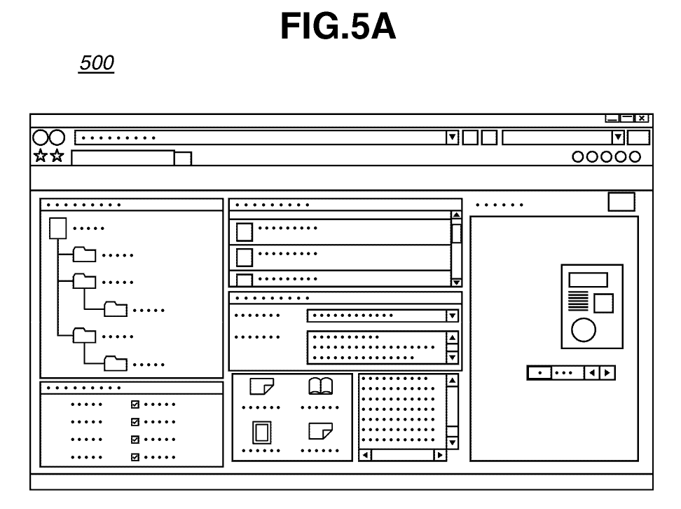

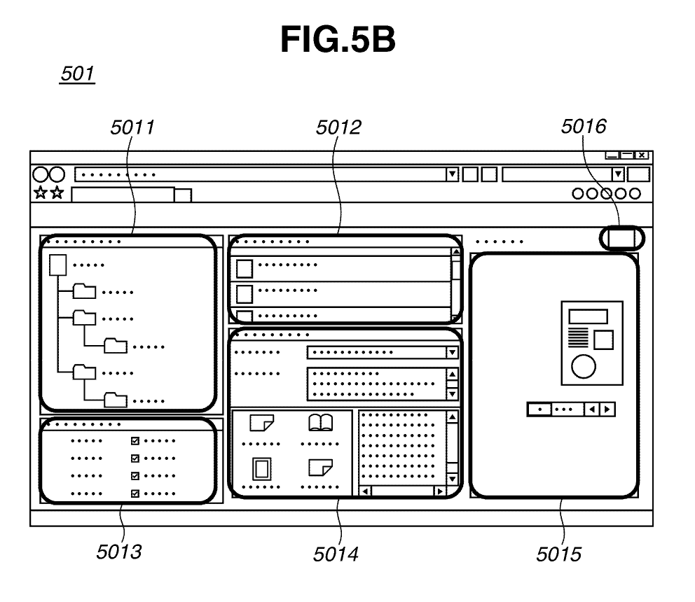

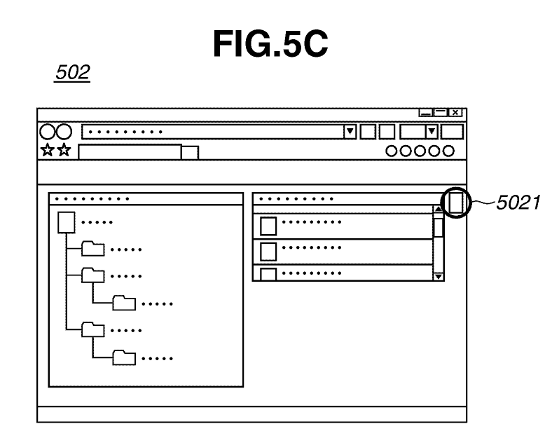

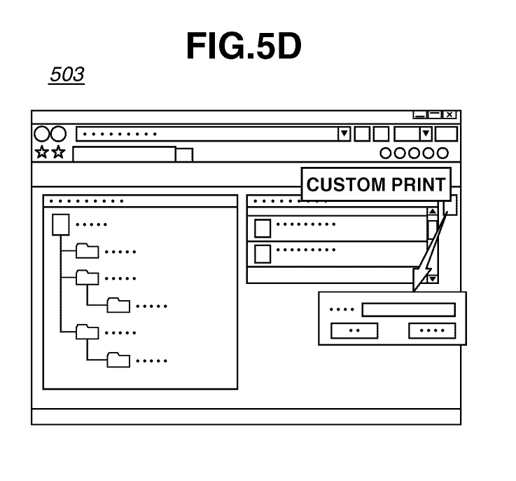

FIG. 5A is a diagram illustrating an example of a UI which is viewed from a browser of the client terminal 1003 directly before final printing processing.

A UI 500 is a UI which is viewed from a browser of the client terminal 1003 directly before final printing processing.

FIG. 5B is a diagram illustrating an example of combination of portlets.

When the UI 500 in FIG. 5A is divided for each unit, as shown by 501 in FIG. 5B, it includes a set of one button and five sites. Each site is a component described by an HTML (it may contain script sentence such as Java Script) referred to as a portlet, which is an example of a UI component.

A portlet 5011 is a service portlet which specifies a storage location (directory) of document data and outputs designated document list information.

A portlet 5012 is a document designation service portlet. The portlet 5012 can display any document list. Normally, the portlet 5012 displays document list information to be output from the portlet 5011.

A portlet 5013 is a summary conversion service setting item portlet. The portlet 5013 designates a parameter which affects when summary conversion is executed.

A portlet 5014 is an output format (print format) setting portlet from a device. The portlet 5014 sets a parameter item which affects when it is output from a device.

A portlet 5015 is a preview portlet. The portlet 5015 provides a preview combining both an output setting of a service to be provided in the web application server 1001 (in turn, service providing system 3000) and an output setting of the output device 1002.

A button 5016 is an output execution button. The button 5016 is a button for executing output processing according to a setting in a portlet. The button 5016 is described by an HTML (it may contains script sentence such as Java Script) so as to allow output processing execution commands to be transmitted to a device output system by button press action.

A process in which these portlets are generated, combined and distributed, and processing is executed according to this use case will be described below.

First, when it is directly accessed from the client terminal 1003 to the web application server 1001 (in turn, service providing system 3000), only the portlet 5011 and the portlet 5012 are distributed to the client terminal 1003. Thus, it is provided by a UI shown as 502 in FIG. 5C.

FIG. 5C is a diagram illustrating an example of a UI when the web application server 1001 is used. At this time, a button 5021 (provided by “custom print” button) for accessing this integrated output system is displayed. Access to this integrated output system does not directly access the service providing system from a browser of the client terminal 1003 but refers to that which accesses the service providing system via the output device system.

When a user presses “custom print” button 5021, as shown by 503 in FIG. 5D, an address for accessing the output device system (connection request response unit 3011 thereof) or a dialog so as to allow a network identification name to be designated is displayed.

FIG. 5D is a diagram illustrating an example of access to an integrated output system. A user designates the output device system 3010 via a dialog illustrated in FIG. 5D to press an OK button. Then, a connection request is transmitted from a browser to the output device system 3010. At this time, the address of the service providing system 3000 and session information used in access to the service providing system 3000 are transmitted from the client terminal 1003 to the output device system 3010.

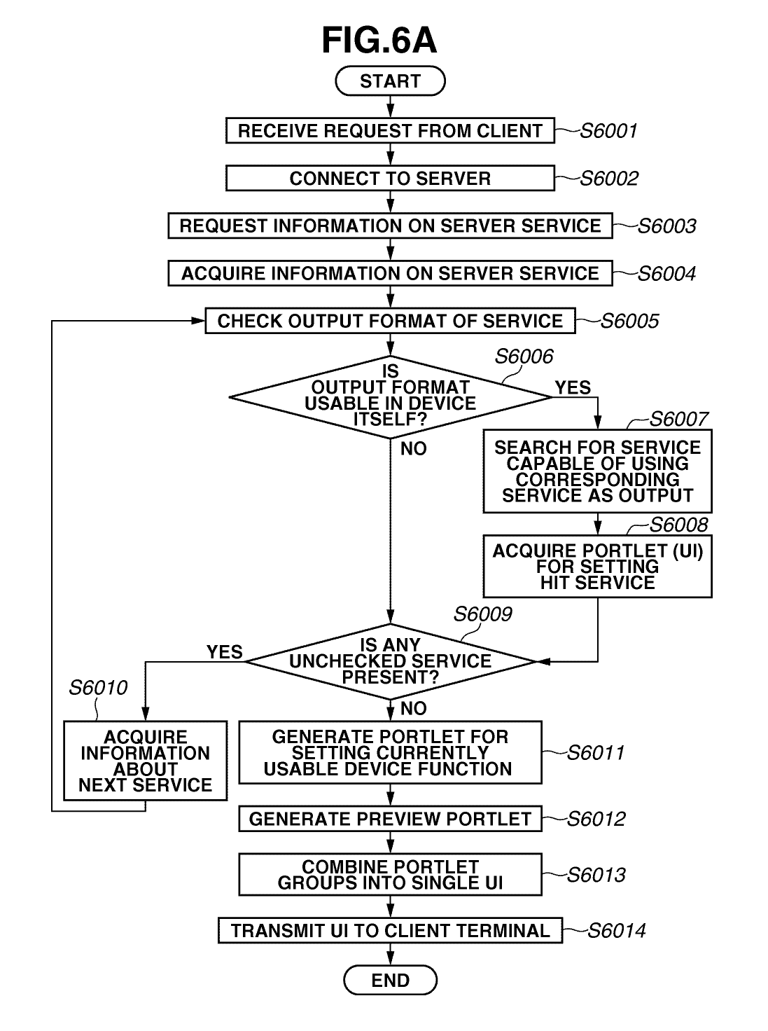

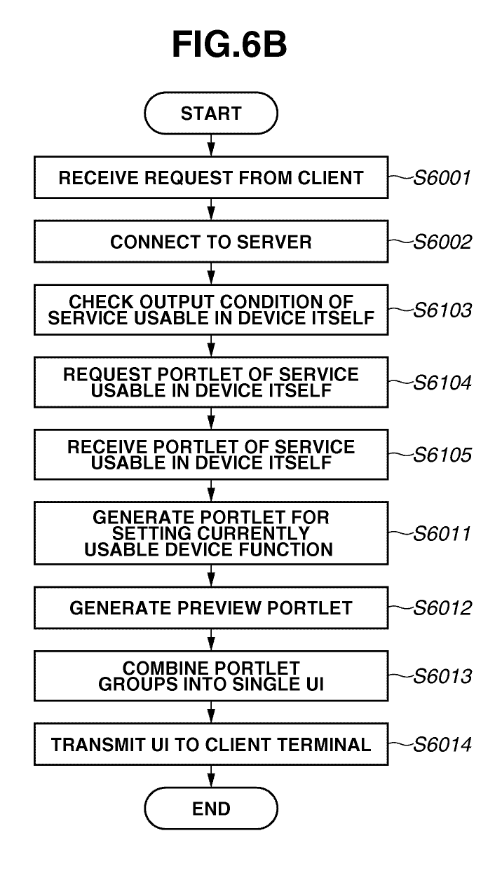

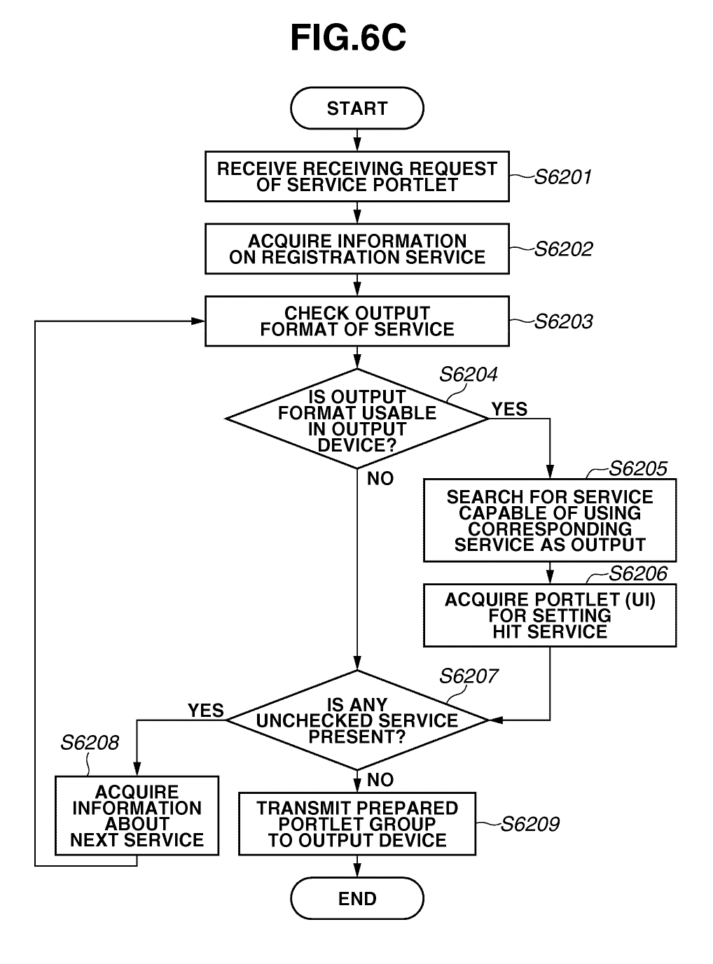

FIG. 6A is a flowchart illustrating an example of processing which is executed on the output device 1002.

In step S6001, the output device system 3010 receives a connection request from the client terminal 1003. In step S6002, the output device system 3010 receiving the connection request accesses the service providing system 3000 based on an address which is an example of identification information of the service providing system 3000 simultaneously received with the connection request from the client terminal 1003. Further, in step S6003, the output device system 3010 transmits an acquisition request of information about a service which is provided by the web application server 1001 to the web application server 1001 (or service providing system 3000). More specifically, the output device system 3010 transmits session information about connection between the client terminal 1003 and the web application server 1001 delivered from the client terminal 1003 when connection is required with the session information contained in the acquisition request.

The main control unit 3002 of the service providing system 3000 receiving the acquisition request from the output device system 3010 commands the service management unit 3007 so as to list information on a service which can be used by a user at the client terminal 1003 based on session information contained in the acquisition request. The listed information (information about service) is transmitted to the output device system 3010 of a request origin by the service providing system 3000. In step S6004, the output device system 3010 receives information about the above-described service (service information) from the service providing system 3000.

With respect to the received service information, the output device system 3010 determines in steps S6005 to S6010 whether it can be output with a data format which can be processed by a device (e.g., printing unit 306, scanner unit 313 or the like) of the apparatus itself (image processing apparatus itself). For example, when a data format which can be subjected to output processing by the device has been PDF/BMP/PS, the output format of a service needs to be any of these formats. In other words, in step S6006, the output device system 3010 checks whether the output format of a service determined (checked) by the output device system 3010 in step S6005 corresponds to any of these PDF/BMP/PS. When it does not correspond thereto, the output device system 3010 passes through steps S6009 to S6010 and repeats similar checks to a next unchecked service (service information) among service information. In the above-described example, the check (determination) is executed on the condition whether the data format (PDF, PS or the like) can be processed. However, it may be determined whether the data format can be subjected to output processing by a device on the condition of an output data size, an output paper size (only when it is invariable) or the like.

Now, a service (second service) that a service (first service), in which the output device system 3010 has determined in step S6006 to be an output format that output of a service can be processed by the system itself, outputs data with an acceptable input format can be regarded as a service to be usable in a device of the output device system 3010 with the first service passed through. Thus, such a service can also be regarded as a service which executes output in a data format that can be processed by the system itself. For example, a document directory service is considered in which when a storage bus of document data is designated (input), an individual document data identifier is transmitted. In this case, if there is a service so as to output PDF data based on the individual document data identifier, it can be determined that this document directory service is also a service which outputs data that can finally be processed by a device of the output device system 3010.

Thus, in step S6007, the output device system 3010 also searches for a service to be an output format in agreement with the output format of the above-described first service from a service group (the above-described service information) which is provided by the service providing system 3000. In step S6008, the output device system 3010 downloads a portlet concerning a service found by search in steps S6006 and S6007 (portlet group downloaded like this is set to portlet group 1). When all services have been checked by processing in steps S6005 to S6010, in the output device system 3010, the processing proceeds to step S6011. In step S6011, the main control unit 3012 of the output device system 3010 commands the device state checking unit 3015 to grasp the capability and the state (capability information and state information) of the system itself from the state of paper feed of the system itself or the situation of option installation such as a finisher. Based on this grasped capability and state, the main control unit 3012 of the output device system 3010 commands the device setting UI generation unit 3016 to generate an output setting portlet of an output device. On this portlet, for example as a print format, a paper size, the number of printing, a page layout, and a bookbinding form can be designated. It may be separated into a plurality of portlets (this portlet group is set to portlet group 2).

Next, in step S6012, the output device system 3010 generates a preview portlet which is an example of a preview component reflecting the setting of the portlet group 1 and the portlet group 2. First, the main control unit 3012 of the output device system 3010 requests an output preview image which is assumed when the portlet group 1 is used to the service providing system 3000 through the web server connection unit 3014. The main control unit 3012 delivers the preview image received from the service providing system 3000 to the preview generation unit 3017 and also generates the preview portlet which converts it into an image reflecting setting information of the portlet group 2 to display it. In step S6013, the output device system 3010 combines (joins) the portlet group 1, the portlet group 2, the preview portlet, and an output execution button which provides a trigger to execute output set in these portlets to provide a single UI (refer to FIG. 5A).

In step S6014, the output device system 3010 replies (or transmits) the combined UI (UI screen) to the client terminal 1003. The client terminal 1003 receives this combined UI. A user optionally changes the setting. When a change of the setting is performed, the contents of the changed setting are notified to the output device system 3010 and the service providing system 3000. The notification of this change of the setting triggers execution of update of the preview image to be distributed from the service providing system 3000 and preview regeneration in the output device system 3010. Thus, the preview portlet is dynamically updated.

When a user presses an output execution button displayed on the client terminal 1003, the current setting is notified to the output device system 3010 and the service providing system 3000, and output processing is executed according to the above-described setting. More specifically, the output processing (in this use case, summary conversion processing) is executed in the service providing system 3000. This output result is stored in the temporally area of the service providing system 3000 and can be accessed only from the output device system 3010 of a request origin which is specified by session information. Next, the output device system 3010 accesses the service providing system 3000 to acquire the generated output result. After the output device system 3010 acquires the output result, the output unit 3019 executes output processing based on the commands of the main control unit 3012 according to the output setting (in this use case, bookbinding output) designated for an output device.

When final output has been completed, the output device system 3010 notifies the service providing system 3000 of that (final output has been completed). When the service providing system 3000 receives completion notification from the output device system 3010, it deletes the intermediate product 4002 (in this use case, document after summary conversion) generated as the output result on the service providing system 3000 side. Then, the output device system 3010 provides a completed screen to the client terminal 1003 and also redirects to an address of the web application server 1001 to which the client terminal 1003 has originally accessed.

According to the present exemplary embodiment, even under an environment so that only one way communication to the web application server 1001 which provides a service from the output device 1002 is accepted, a preview reflecting an output setting of both a service and an output device can be generated and provided.

Further, since a target document can be specified and an output format from a device can be designated on a single UI, even when a plurality of documents is intended to be output as one output material, a user does not need to devise identifier assignment for output in advance to operate it. Thus, operability can be improved.

Furthermore, when data on a server is not output as it is but a result processed by a service which is provided by the server is also intended to be output from a device, both of processing of a service and output from a device can be executed in one transaction. Accordingly, a user does not need to manually perform preliminary preparation for output of an intermediate product and post-processing such as deletion of the intermediate product. Thus, operability can be improved.

Still furthermore, an output material from the web application server 1001 can also be printed without downloading to the client terminal 1003. Thus, a problem so that electronic data is leaked from the client terminal 1003 can also be avoided.

In the above-described exemplary embodiment, in steps S6005 to S6010, the output device system 3010 has executed specified processing of a service (service in which output format of service is output format which can be processed by device itself) usable by a device itself. However, normally, the output device side is frequently poor hardware such as a CPU. Thus, it is not preferable to execute many processing on the output device side. Accordingly, processing corresponding to processing in steps S6005 to S6010 may also be executed in the service providing system 3000.

FIG. 6B is a flowchart illustrating an example of processing which is executed on the output device 1002. In FIG. 6B, steps which execute the same processing as that in FIG. 6A are denoted with the same reference numerals.

Similarly in steps S6001 and S6002 in FIG. 6A, the output device system 3010 executes steps S6001 and S6002 in FIG. 6B. The details of processing are similar to those in steps S6001 and S6002.

Next, in step S6103, the main control unit 3012 of the output device system 3010 commands the device state checking unit 3015, checks the current state of paper feed and the situation of option installation such as a finisher, and grapes the current capability and state. The output device system 3010 specifies a data format that a device can process as the output format of data from this current capability and state.

In step S6104, the output device system 3010 transmits the data format that the device specified in step S6103 can process to the service providing system 3000 as a parameter and requests a service portlet usable in the device. The output device system 3010 includes session information, which is contained in a connection request received from the client terminal 1003 in step S6001, in a parameter and transmits it to the service providing system 3000.

When the above-described request is transmitted from the output device system 3010 to the service providing system 3000 in step S6104, processing illustrated in FIG. 6C is executed in the service providing system 3000.

FIG. 6C is a flowchart illustrating an example of processing which is executed on the web application server 1001.

In step S6201, the data transmitting and receiving unit 3001 of the service providing system 3000 receives the receiving request of the service portlet from the output device system 3010. The received receiving request is transmitted from the data transmitting and receiving unit 3001 to the main control unit 3002. The main control unit 3002 extracts information on a data format which is a parameter contained in a request and can be processed by a device, and session information. In step S6202, the main control unit 3002 delivers the session information and commands the service management unit 3007 so as to acquire a service that a user of the client terminal 1003 can use among information on services which are provided by the web application server 1001 itself (server itself). The service management unit 3007 acquires a service that a user of the client terminal 1003 can use based on the session information (acquire service information).

With respect to the acquired service information, the main control unit 3002 compares the acquired service information and a data format which can be processed by a request source device to specify a service, which is usable (can be processed) in a request source device, by processing in steps S6203 to S6208. This processing in steps S6203 to S6208 is similar to that of the above-described processing in steps S6005 to S6010. In step S6204, similarly to step S6006, when the main control unit 3002 determines that output of a service is an output format which can be processed by a request device, in step S6205, the main control unit 3002 searches a service which can be processed by the request device if it is via a service. In step 6206, the main control unit 3002 causes the web UI generation unit 3004 to generate a portlet concerning a service which has been found by search in step S6205 and prepares it for transmitting it to the request origin device later. When all services have been checked, in the main control unit 3002, the processing proceeds to step S6209 and then a prepared portlet group is transmitted to the output device system 3010.

In step S6209, when the portlet group is transmitted from the service providing system 3000 to the output device system 3010, the output device system 3010 executes processing to step S6105 illustrated in FIG. 6B. In step S6105, the web server connection unit 3014 delivers the received portlet group to the main control unit 3012 (in the present exemplary embodiment, portlet group received like this is set to portlet group 1). Subsequently, processing similar to the processing in steps S6011 to S6014 illustrated in FIG. 6A is executed. Then, the combined UI is transmitted from the output device 1002 to the client terminal 1003.

According to the present exemplary embodiment, a load on the output device 1002 side can be reduced by processing a part of processing on the output device 1002 side poor in hardware such as a CPU on the web application server 1001 side normally having high-performance hardware.

According to the exemplary embodiments described above, a preview considering an output format of both the web application server and the output device can be provided and also operability concerning output can be improved.

More specifically, even under an environment so that only one way communication to the web application server which provides a service from the output device is accepted, a target document can be specified and an output format from a device can be designated on a single UI. Accordingly, even when a plurality of documents is intended to be output as one output material, a user does not need to devise identifier assignment for output in advance to operate it. Thus, operability can be improved.

Further, when data on a web application server is not output as it is but a result processed by a service which is provided by the server is also intended to be output from a device, both of processing of a service and output from a device can be executed in one transaction. Accordingly, a user does not need to manually perform preliminary preparation for output of an intermediate product and post-processing such as deletion of the intermediate product. Thus, operability can be improved.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-266505 filed Oct. 15, 2008, which is hereby incorporated by reference herein in its entirety.

What is claimed is:

1. An image processing apparatus comprising:
a connection unit configured to connect to a server apparatus based on identification information on the server apparatus contained in a connection request from a client terminal apparatus;
an acquisition unit configured to acquire a user interface (UI) component concerning a service which can be used by a user in the client terminal apparatus and has an output format capable of processing an output format of the service by a device of the image processing apparatus among services provided by the server apparatus based on session information about a connection between the client terminal apparatus contained in the connection request and the server apparatus and the output format that can be processed by the device of the image processing apparatus;
a generation unit configured to generate a preview component for an output material based on an output setting of the UI component acquired by the acquisition unit and an output setting of the UI component of the device of the image processing apparatus;
a combining unit configured to combine the UI component acquired by the acquisition unit, the UI component of the device of the image processing apparatus, and the preview component generated by the generation unit into a single UI screen; and
a transmission unit configured to transmit the UI screen combined by the combining unit to the client terminal apparatus.

2. The image processing apparatus according to claim 1, wherein the acquisition unit acquires service information about a service which can be used by a user in the client terminal apparatus from the server apparatus based on session information about the connection between the client terminal apparatus contained in the connection request and the server apparatus, determines whether an output format concerning a service indicated by the service information can be processed by the device of the image processing apparatus based on the service information and capability information about the device of the image processing apparatus, and, when it is determined that the output format can be processed by the device of the image processing apparatus, downloads the UI component concerning the service from the server apparatus.

3. The image processing apparatus according to claim 1, wherein the acquisition unit transmits the acquisition request of the UI component concerning the service which can be used by the user in the client terminal apparatus and has the output format capable of processing the output format of the service by the device of the image processing apparatus among services provided by the server apparatus containing session information about the connection between the client terminal apparatus contained in the connection request and the server apparatus and the output format that can be processed by the device of the image processing apparatus specified based on capability information about the device of the image processing apparatus to the server apparatus, and receives the UI component corresponding to the acquisition request from the server apparatus.

4. A server apparatus comprising:
a receiving unit configured to receive an acquisition request of a user interface (UI) component concerning a service which can be used by a user in a client terminal apparatus and has an output format capable of processing the output format of the service by a device of an image processing apparatus among services provided by the server apparatus, containing session information about a session of the client terminal apparatus and the server apparatus and capability information on the device of the image processing apparatus from the image processing apparatus;
a service information acquisition unit configured to acquire service information concerning the service which can be used by the user in the client terminal apparatus based on the session information contained in the acquisition request received by the receiving unit;
a determination unit configured to determine whether an output format concerning the service indicated by the service information can be processed by the device of the image processing apparatus based on the service information acquired by the service information acquisition unit and the capability information on the device of the image processing apparatus contained in the acquisition request received by the receiving unit; and
a transmission unit configured to transmit the UI component concerning the service determined to be the output format which can be processed by the device of the image processing apparatus by the determination unit to the image processing apparatus.

5. A method for controlling an image processing apparatus, the method comprising:
connecting to a server apparatus based on identification information on the server apparatus contained in a connection request from a client terminal apparatus;
acquiring a user interface (UI) component concerning a service which can be used by a user in the client terminal apparatus and has an output format capable of processing the output format of the service by a device of the image processing apparatus among services provided by the server apparatus from the server apparatus based on session information about connection between the client terminal apparatus contained in the connection request and the server apparatus and the output format that can be processed by the device of the image processing apparatus;
generating a preview component for an output material based on an output setting of the acquired UI component and an output setting of the UI component of the device of the image processing apparatus;
combining the acquired UI component, the UI component of the device of the image processing apparatus, and the generated preview component into a single UI screen; and
transmitting the combined UI screen to the client terminal apparatus.

6. The method according to claim 5, further comprising:
acquiring service information about the service which can be used by the user in the client terminal apparatus from the server apparatus based on session information about connection between the client terminal apparatus contained in the connection request and the server apparatus;
determining whether an output format concerning a service indicated by the service information is an output format that can be processed by the device of the image processing apparatus based on the service information and capability information about the device of the image processing apparatus; and
downloading the UI component concerning the service determined that the output format can be processed by the device of the image processing apparatus from the server apparatus.

7. The method according to claim 5, further comprising:
transmitting the acquisition request of the UI component concerning the service which can be used by the user in the client terminal apparatus and has the output format capable of processing the output format of the service by the device of the image processing apparatus among services provided by the server apparatus containing session information about connection between the client terminal apparatus contained in the connection request and the server apparatus and the output format that can be processed by the device of the image processing apparatus specified based on capability information about the device of the image processing apparatus to the server apparatus; and
receiving the UI component corresponding to the acquisition request from the server apparatus.

8. A method for controlling a server apparatus, the method comprising:
receiving an acquisition request of a user interface (UI) component concerning a service which can be used by a user in the client terminal apparatus and has an output format capable of processing the output format of the service by a device of an image processing apparatus among services provided by the server apparatus containing session information about a session of the client terminal apparatus and the server apparatus and capability information on the device of the image processing apparatus from the image processing apparatus;
acquiring service information concerning the service which can be used by the user in the client terminal apparatus based on the session information contained in the received acquisition request;
determining whether an output format concerning the service indicated by the service information can be processed by the device of the image processing apparatus based on the acquired service information and the capability information on the device of the image processing apparatus contained in the received acquisition request; and
transmitting the UI component concerning the service determined to be an output format which can be processed by the device of the image processing apparatus to the image processing apparatus.

9. A computer-readable storage medium storing a program for causing a computer to execute the method according to claim 5.

10. A computer-readable storage medium storing a program for causing a computer to execute the method according to claim 8.
